(19) United States
(12) Patent Application Publication
(10) Pub. No.: US 2010/0306122 A1
(43) Pub. Date: Dec. 2, 2010

(54) System and Method for Providing an Electronic Literature Club in a Network Environment

(75) Inventor: Shmuel Shaffer, Palo Alto, CA (US)

Correspondence Address: Patent Capital Group - Cisco, 6119 McCommas, Dallas, TX, 75214, US

(73) Assignee: Cisco Technology,Inc.

(21) Appl. No.: 12/475,165

(22) Filed: May 29, 2009

(51) Int. Cl. G06Q 99/00; G06F 15/16; G06Q 50/00; G06F 17/30

(52) U.S. Cl. 705/319; 709/206

(57) ABSTRACT

A method is provided in one example embodiment and includes receiving progress data associated with an end user reading an electronic piece of literature and receiving a request from the end user to interact with an additional end user about the electronic piece of literature. The method can further include identifying the additional end user who is also reading the electronic piece of literature in order to form a reading group associated with the electronic piece of literature. In more specific embodiments, the identifying further includes identifying progress data for the additional end user such that the reading group is formed of the end users who are at a similar location in the electronic piece of literature.

### TECHNICAL FIELD

This disclosure relates in general to the field of social networks and, more particularly, to providing an electronic literature club in a network environment.

### BACKGROUND

People who share common experiences often gather to exchange ideas regarding their experiences. For example, people who read the same book may form a book club with the goal of conversing about the book they have read. Similarly, people who perform a certain intellectual task may benefit from creating a social network associated with the experience. For example, students who receive a specific homework assignment may form a study group and tackle the homework as a team rather than individually. In either one of the cases described above, the creation of the social network (book club or study group) is a planned activity, which typically takes place before the team gets together. With the introduction of new forms of reading technology (e.g., digital readers from Sony and Amazon.com), content publishing is shifting from a paper form to a digital format. Hence, many individuals are now reading their written materials in an electronic format. The ability to properly manage resources for this new group of end users provides a significant challenge to designers, component manufacturers, service providers, and system administrators alike.

### BRIEF DESCRIPTION OF THE DRAWINGS

To provide a more complete understanding of example embodiments and features and advantages thereof, reference is made to the following description, taken in conjunction with the accompanying figures, wherein like reference numerals represent like parts, in which:

FIG. 1 is a simplified block diagram of a system for associating end users in an electronic network environment in accordance with one embodiment;

FIG. 2 is a simplified schematic diagram of an example configuration of electronic reading devices in accordance with one embodiment; and

FIG. 3 is a simplified flowchart illustrating an example operational flow involving the system in accordance with one embodiment.

### DETAILED DESCRIPTION OF EXAMPLE EMBODIMENTS

### Overview

A method is provided in one example embodiment and includes receiving progress data associated with an end user reading an electronic piece of literature and receiving a request from the end user to interact with an additional end user about the electronic piece of literature. The method can further include identifying the additional end user who is also reading the electronic piece of literature in order to form a reading group associated with the electronic piece of literature. In more specific embodiments, the identifying further includes identifying progress data for the additional end user such that the reading group is formed of the end users who are at a similar location in the electronic piece of literature. In still other embodiments, the method includes providing a communications platform for the end users to interact based on the electronic piece of literature. The communications platform provides a forum in which the end users can write text to each other about the piece of electronic literature.

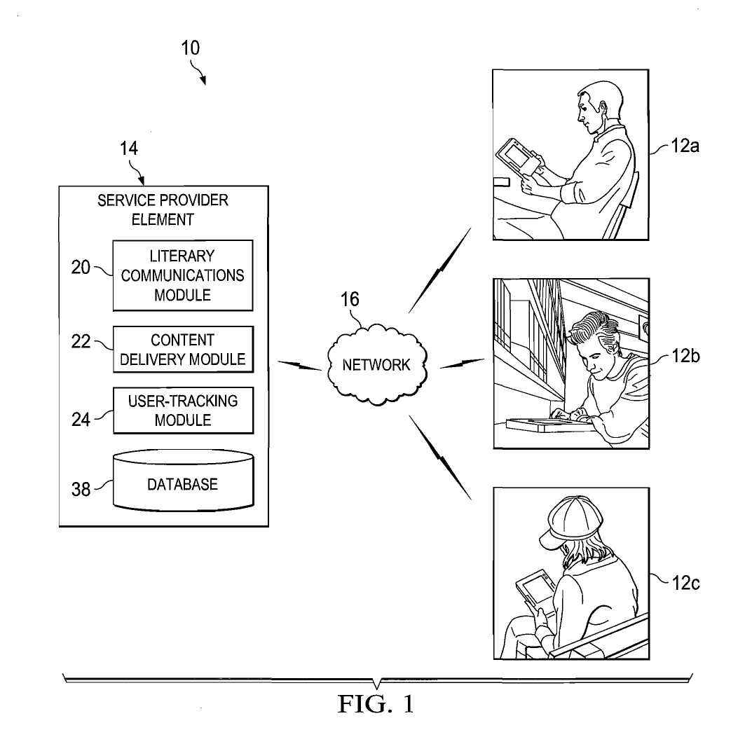

Turning to FIG. 1, FIG. 1 illustrates a system 10 for associating end users in an electronic network environment. FIG. 1 may include a service provider element 14 configured to couple with a network 16, which can facilitate communications with various electronic reading devices 12a-c. In the example implementation of FIG. 1, electronic reading devices 12a-c are being operated by various end users: Joe, Jason, and Karen respectively. Each of electronic reading devices 12a-c can be capable of representing words, text, images, books, magazines, articles, journals, newspapers, etc. (collectively referred to herein as ‘literature’) in an electronic format for potential viewing by end users on their respective reading devices. In one example implementation, service provider element 14 includes a literary communications module 20, a content delivery module 22, a user-tracking module 24, and a database 38. Additional details relating to the infrastructure and interfacing options provided to the end users are discussed below.

Service provider element 14 and electronic reading devices 12a-c may leverage network 16 (e.g., a wide area network (WAN), a local area network (LAN), a wireless LAN, a Wi-Fi hotspot, a virtual private network (VPN), etc.) for communication activities. Each of the elements of FIG. 1 may couple to one another through simple interfaces or through any other suitable connection (wired or wireless), which provides a viable pathway for communications. Additionally, any one or more of these elements may be combined or removed from the architecture based on particular configuration needs. System 10 may include a configuration capable of transmission control protocol/internet protocol (TCP/IP) communications for the transmission or reception of packets in a network. System 10 may also operate in conjunction with a user datagram protocol/IP (UDP/IP) or any other suitable protocol or tunneling technique, where appropriate and based on particular needs.

In certain example embodiments, system 10 facilitates the creation of content-dependent dynamic collaborations. In some example implementations, system 10 can track the reading progress of a user, as he reads a given piece of digital literature and then subsequently create a social group for discussing the piece of literature. Such a configuration can offer a forum for collaboration and for information exchanges amongst people who are reading the same item (or potentially even reading the same chapter or page in a given piece of electronic literature). In general terms, system 10 can expand the utilization of wireless connectivity for electronic literature being read by various end users and, further, use this to publish the progress data of the user/reader (in a given literary work), to other end users, who may be interested in conversing about this literature.

In another example implementation, the privacy of the end user is preserved and, as such, the progress of a specific user is not published. Rather, as a user indicates to the system that he would like to collaborate with other users, his place in the book is sent to service provider element 14. The service provider maintains (e.g., in its confidential database) progress information of other users. The service provider searches its database for a best match based on content and, further, establishes a connection between the two or more participants without compromising their identity (or anonymity). It can be left up to the users to reveal who they are to each other; however, in one implementation, the system does not do this by default or automatically.

More specific to the operational aspects of the presented concepts, as a user starts reading a specific piece of literature (e.g., an e-Book), their location in the specific content is established. This end user's presence in the e-Book can include heightened granularity such that the specific page, chapter, line, etc. may be tracked as it is read by the end user. As used herein in this Specification, the term ‘progress data’ is meant to encompass any such location information (i.e., the place in the book in which the end user has stopped, which could be the very first page in the case where the end user has yet to begin the literary work). Additionally, the progress data associated with the end user may include a subject and its attributes. The attributes may reveal an academic level for which the e-book, the e-group, and the subject are intended. As an example that is illustrative, the attribute field could help connect grade-eleven students who study mathematical sequences, rather than joining these students with a researcher who is reading about genetic sequences. Other attributes could be used to identify possible e-groups (or end users) reserved solely for professors, as opposed to students, or users who speak a given native language, or users from a given geographic area, or users that can share any other possible attribute. In one example implementation, system 10 can leverage this progress data to form ad-hoc social networks associated with a specific reading. This group formation and tracking activity is further detailed below with reference to various example scenarios.

A reading group is a group that may be physical or virtual (i.e., network based). Once assembled, the reading group can offer a forum for people to discuss a piece of literature (e.g., a book, an article, a newspaper, an academic assignment, etc.). The forum offers a platform for collaboration and an exchange of opinions, questions, thoughts, etc. by members of the group. As used herein, in this Specification, the term “reading group” may include any type of social network in which members of the group have some type of association or affiliation with respect to a piece of literature. This may include reading clubs, blogs, chat rooms, book groups, and book discussion groups. It may further extend to other scenarios, which involve academic environments. In such environments, the reading group could include members of a class, members of a certain academic club, members of a research team, members of a campus (or geographic location within the campus), etc. In still other scenarios, system 10 can facilitate a coop-like study group, where students support other students in order to accumulate credit that will enable them to gain access to the study group for future assistance with their own homework.

In other scenarios that involve financial publications, the reading group could be an investment club. In still other scenarios that involve corporations, the reading group could be members of a company, a particular business unit, a particular office location, an office floor, a particular technology, etc. The reading group is based on the literature to be examined and, thus, the reading group could be any aggregation of individuals seeking to exchange some thought, or seeking to read the thoughts of others about a given piece of literature. Attributes may be included in the progress data traversing through service provider element 14 and/or through electronic reading devices 12a-c to signify these groupings or to identify these particular types of end users.

E-literature (short for electronic literature) is a digital representation of a piece of literature. E-literature can be read on personal computers, smart phones, or on dedicated hardware devices (e.g., e-Book readers, e-Book devices, etc.). Many mobile phones (such as the I-Phone) can also be used to read eBooks. E-literature readers include Amazon's Kindle model, or Sony's PRS-500, Pixelar e-Reader by Pixelar, Readius foldable eBook reader by Polymer Vision, Digital Reader by iRex, Cybook Gen3 by Bookeen, Hanlin eReader by Jinke, Wattpad for Mobile Java devices and other mobile phones, etc. As used herein in this Specification, the term “electronic reading device” is meant to encompass all of these elements that can be used to read electronic literature. This would necessarily include all of the aforementioned items (personal computers, smart phones, dedicated hardware devices, e-Book readers, mobile phones, etc.) and various other handheld devices that are capable of representing literary materials in electronic format. There are various acceptable formats for such e-reading activities (e.g., .text, .html, .htm, etc.), as the associated e-text forms the digital media equivalent of a conventional printed book. Other formats could include Amazon Kindle (AZW) Format, Open Electronic Book Package Format, Arghos Diffusion, Flip Books, NISO Z39.86 Format, Text Encoding Initiative, Portable Document Format (PDF), PostScript, DjVu, Microsoft LIT, eReader, DNL Reader, Newton eBook, iPod Notes, Libris, Mobipocket, IDPF/EPUB, SSReader, etc.

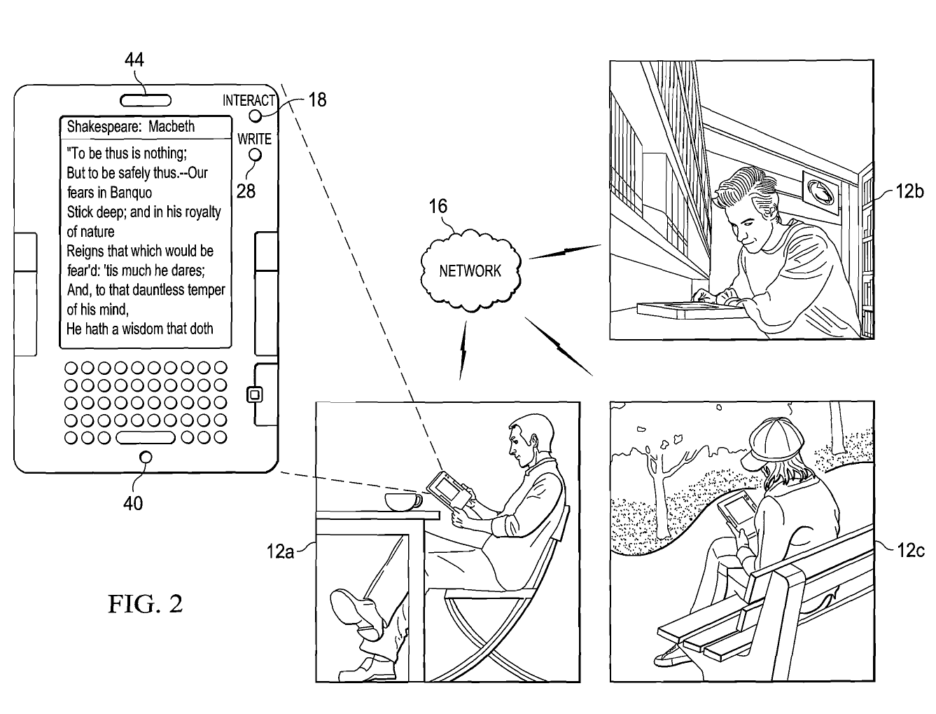

For purposes of explanation, FIG. 2 is discussed in conjunction with FIG. 1. FIG. 2 is a simplified schematic diagram illustrating additional details relating to each of the electronic reading devices 12a-c. In one example implementation, a hard button (interact element 18) is provided on electronic reading device 12a to allow Joe to trigger interaction with one or more end users that are reviewing this particular piece of literature. Further, a second hard button (a write element 28) is provided to allow a person to write text (e.g., type words, or to hand-draw symbols or language, etc.) on the screen of electronic reading device 12a such that these notes can be viewed by another end user of the reading group. These buttons may work collectively to allow Joe either to express his views on this particular book, or to access the views of others associated with this reading. In this non-limiting example, the hard buttons have been arbitrarily labeled ‘interact’ and ‘write’ and are meant to encompass various other elements that could perform similar operations or activities.

For example, the Interact button may establish a conference bridge, which facilitates verbal exchange between members of the team. Other communication modalities or any hybrid set of communication modalities is encompassed by the presented concepts. Alternatively, the hard buttons could be replaced by a soft button, or be provided through any type of application software that would allow Joe to conduct such activities. As used herein in this Specification, the term “interact element” and “write element” are meant to encompass a hard button, a soft button, software, menus, applications, or any other component that could afford the ability to communicate (inclusive of simple viewing activities) with other end users. Note also that electronic reading device 12a includes a speaker 44 and a microphone 40 that would allow an end user to interact with other end users, who would similarly have devices that would facilitate such audio communications. The system may connect the users directly or (when there are more than two users in any given team) establish a conference bridge (not shown in the FIGURE for purposes of simplification). In accordance with one embodiment, the conference bridge resides in service provider element 14, but could be provisioned elsewhere based on particular needs.

Service provider element 14 represents an entity that can deliver content to multiple end users connected to network 30. In one example, service provider element 14 is a server or a collection of servers, which reside in a data center of the service provider and which are attached to the network. Alternatively, service provider element 14 can be any other element capable of performing the activities outlined herein. Each of the components included in service provider element 14 can interact with each other using various interfaces, or these elements can be arranged differently or consolidated where one or more of the components are combined or eliminated. Many of these alternatives may be based on particular architecture needs and are certainly within the broad scope of the embodiments presented herein.

In one example, service provider element 14 includes user-tracking module 24 that stores (or otherwise has access to) data relating to: which users have purchased or otherwise gained access to certain pieces of literature, which users have read certain pieces of literature, which users are currently reading a piece of literature, and/or when any such activities occur. In certain specific examples, user-tracking module 24 has the ability to be precise in identifying exact timeframes and specific end users who are accessing a given piece of literature at a specific location (e.g., a specific page, a specific chapter, a specific section in the book, just beginning the book, finishing the book, etc.). Thus, an end user reading Scene III of William Shakespeare's Macbeth can have access to the thoughts of another end user, who might be reading the same Scene, and who might be possibly residing in a different country in a different time zone, etc. In a general sense, user-tracking module 24 has the ability to interface with electronic reading devices 12a-c in order to create an immediate ad-hoc network for connecting end users, whose commonality lies in the literature being read electronically. In addition, literary communications module 20 can facilitate end-user communications (as detailed below) and/or archive communications or postings involving end users who have reviewed the given piece of literature. This stored data can be included in database 38, or offered in any other suitable location. In one mode of operation, the system does not track the progress of users. Rather, as a user requests to establish an e-group or to join an e-group related to topic he is reading the progress status of this said user is provided by his e-book 12 to service provider element 14. The users effectively grant service provider element 14 the ability to monitor their progress, when they request to join an e-group. The system can store the request and the related user progress status in the database. The system then scans the database for similar requests from other users. If the system finds that a similar e-team has been established, the system enables the user to join the e-group. In accordance with one embodiment, the system first asks the members of the e-team if they are willing to accept another user. In case there is no active e-team associated with the requested subject (e.g., progress in a specific e-book), the system establishes an e-team and connects the two users. In case there is no other user who is interested to join an e-team for the requested subject, the system stores the request in its database and waits for other potential members to request establishment of an e-team for this topic (potentially accompanied by a precise progress status).

Note that service provider element 14 (for example, via user-tracking module 24) can identify a related timeframe in which specific book locations are being read by end users. Consider that some end users may enjoy hearing first impressions as they encounter Chapter 7 of a book for the first time. In this sense, the reading material being shared by Jason, Karen, and Joe could be done in real time. In contrast, other end users may enjoy hearing from end users who have already digested the material of Chapter 7, where these end users have deciphered a grander meaning of Chapter 7, or how Chapter 7 fits into the larger story.

In one example implementation, a daily timeframe could be used by service provider element 14 in identifying which end users are currently reviewing a piece of literature. Hence, if Joe and Karen were identified as reading Scene III of Shakespeare's Macbeth on Thursday Apr. 15, 2009, and if Joe were interested in discussing this Scene, service provider element 14 (for example, via user-tracking module 24) would be able to identify this commonality and facilitate communications involving these two end users. Again, these communications between Joe and Karen could involve a simple posting, or referencing a conversation (via instant messaging, conferencing bridge, a string, a blog, a website, etc.) such that these two end users can exchange thoughts about Macbeth's Scene III. Some example collaborative platforms are detailed below.

Another timeframe could be weekly such that any end user that has accessed Scene III of Macbeth electronically at any time during the previous seven days would be identified for a possible connection with Joe. For more popular readings, the timeframe could be hourly or even on a minute basis. In academic environments, such a timeframe could be dictated by the semester, the quarter, the weekly reading assignments, or date back to previous timeframes associated with particular classes, readings, instructors, assignments, etc. Any such permutations are clearly within the concepts presented herein.

Literary communication module 20 can serve as a communicating platform for the end users, who wish to post their thoughts, questions, or commentary concerning a given piece of literature. In one example, literary communications module 20 can be used to facilitate such communications, but in another example implementation such communications are provided via a server connected to network 16. The server can be affiliated, administrated, or operated by service provider element 14, or it may be independent of service provider element 14.

In one example, the end users (once they are matched by the system) can communicate through various types of protocols, such as through instant messaging, through e-mail communications that flow through a website or blog (i.e., the Internet), through video conferencing applications, through texting or short message service protocols, through Bonjour, through Apple iChat, through WebEx software, through Meeting Place software (both of which are web-sharing technologies), through wire-line communication, through Wi-Fi or wireless communications, or through Skype. Skype is an internet software application that allows users to establish instant messaging, voice, or video communication over the Internet. Calls to other users of the service and to free-of-charge numbers are free, while calls to other landlines and mobile phones can be made for a fee. Additional features of Skype include instant messaging, file transfer, and video conferencing. These possible communication platforms are far from exhaustive and they can be provided by service provider element 14, or they may be offered to the end users of the e-group through some other entity [not shown in FIG. 2]. In order to join a reading group, a hard button (such as interact element 18) can be pressed in order to trigger a communication, or to trigger a request for communicating with one or more additional end users about a specified piece of literature. From this point, the end users can agree on the particular communications platform for subsequent communications/conversing about the piece of literature.

In other example embodiments, service provider element 14 has intelligence to redirect the user (such as Joe) to a website that would facilitate the interactive communications outlined herein. Note that there are web pages where users, who read a web page, can blog automatically or add their opinions. Concepts presented herein can provide a process of creating e-groups automatically rather than use static existing chat rooms. Such concepts can make every e-book page, or any e-book subject to a prospective e-group creation object and, further, dynamically establish these e-groups per request of the readers.

Literary communications module 20 can readily allow end users to collaborate with each other without having a pre-existing relationship. In another example implementation, a given end user can filter the people that may be potentially offered to him for interaction about a specific piece of literature. For example, in an academic environment , a student end user could specify that he would like to interact with someone who is reading Scene III of Shakespeare's Macbeth, however the filtering mechanism could indicate that the potential end user should be a Stanford University student (just like this particular end user). In this example, service provider element 14 could be the university itself, which would be equipped to deliver content to its students (in any suitable manner), and to monitor the progress or status of the users as they advance through a given piece of literature. In academic instances, this could further involve mathematical applications in which service provider element 14 could identify an exact problem number being evaluated by multiple students concurrently. Students can elect to access literary communications module 20 for posting their thoughts, or alternatively the students could simply identify other students who are working in the same area and then gather at a local cafe, coffee shop, student building, or other point on the campus. Other communications platforms (as detailed above) could similarly be employed.

In accordance with an e-study group scenario, a student may request to form or join an existing electronic study group related to the homework assignment she is working on. As the user make this selection, one of the electronic reading devices can determine the specific piece of literature the user is reading and, further, even pinpoint the exercise in which the student is engaged. This information may be tracked, for example, through user-tracking module 24, which is systematically gathering information associated with who is reading specific pieces of literature. Service provider element 14 (or a given server) collects similar requests from other students and, where matches are found, students are connected via a collaboration software protocol, as identified previously. In essence, this configuration has allowed a given student to dynamically form an ad-hoc study group.

Other reading group examples could involve users seeking only to interact or otherwise collaborate with coworkers. For example, a person working at General Electric and reading “Straight from the Gut” by former GE CEO Jack Welch, may seek to hear feedback or to resolve questions based only on interaction with other GE workers. This type of ad-hoc collaboration could further extend to corporate end users that systematically review White Papers (which are included within the term ‘article’ as used herein), or technology companies that may be taking part in creating a large specification in which multiple digital readers are being employed by several members of the reading group.

In regards to a possible business use, in employing some of the examples presented herein, a bookseller and an e-Reader vendor can offer business propositions related to the book an end user is reading. For example, people who want to use the dynamically formed groups and the collaboration software may be required to pay membership fees to the service provider. In other scenarios, study groups may be run as a coop community, where students are required to provide tutoring and help for some students of a lower grade in order to be eligible for help from more senior students. Students may elect to pay for the privilege of joining a study group and, thereby, bypass the coop protocol and this would allow them to address their questions immediately, rather than spend their time tutoring other study groups.

Turning to additional examples that may be illustrative, in one example with reference to FIG. 2, one end user is operating his electronic reading device on a park bench, while another user is using his electronic reading device at a university library, and the third user is operating his electronic reading device in a local coffee shop. This virtual reading group (of Joe, Jason, and Karen) has designated a certain piece of literature to be read, evaluated, analyzed, or otherwise discussed. In another example, these end users have no type of social connection before electing to read a certain piece of literature. Each of electronic reading device 12a-c can create an ad-hoc group or join an existing e-group if a given end user triggers some type of button (software or hardware), as explained above.

This particular example relates to an implementation involving an e-Book. In this example, the end user Joe has decided to read William Shakespeare's Macbeth. Joe purchases the e-Book from service provider element 14 and the e-Book is promptly delivered to Joe's electronic reading device. This transmission can be achieved via content delivery module 22. In one example, service provider element 14 can monitor the location at which end users are in their electronic reading. In one mode of operation, Joe's progress is tracked locally in his e-book. This progress can be provided to user tracking module 24, but only as part of Joe's request to establish (or join) an e-team related to his progress in the book.

In this example, service provider element 14 may be Amazon.com and this service provider receives additional requests from Jason and Karen to join an e-team associated with Shakespeare's Macbeth. Service provider element 14 can identify that multiple end users (i.e., Jason and Karen in this example) have acquired an electronic copy of this particular piece of literature and, further, it can associate these end users with each other when requested. In exchange for satisfying these e-group formation requests, Karen and Jason implicitly allow service provider element 14 to track their progress through their identified reading.

For purposes of clarity, it is important to differentiate between the progress monitoring that happens in the e-book itself and the one done by service provider element 14. The e-book (e.g., electronic reading devices 12a-c) may track each time the user scrolls through the book and, for example, know exactly the exact progress of the user in the literature. Service provider element 14, in one example implementation, can become privileged of this information only when the user surrenders it as part of his request to join a subject related e-team.

Returning to Joe's scenario, at some point Joe reached a provocative point in the work such that he was compelled to comment on the book, to listen or to read how others felt about the book (e.g., at a particular passage), or to seek confirmation or clarity in interpreting certain passages within the book. Joe requested to join an electronic ad-hoc book club related to this book. As Joe made this selection (either via a hardware button, a soft button, via a menu, etc.), Joe's electronic reading device (an electronic reader in this case) transmitted this request to service provider element 14, or to a server that is coupled to network 16. Because of Joe's request, Amazon.com is now authorized to track Joe's progress and, in this case, Amazon.com identifies that Joe is on Scene III of Shakespeare's Macbeth and, at the same time, service provider element 14 identifies that Jason and Karen are at the same spot in this particular electronic reading. Service provider element 14 is aware of the status of the progress of the reading for the end users, as they go through each of the electronic pages of the electronic literature. This tracking was authorized/enabled/engendered by the end user requests to form the e-group. The progress of the end users can be updated on a page basis, or the progress could be updated on a chapter basis, or any other particular progress metric can be used and based on particular end user needs. In another example, the progress is monitored in real-time such that an exact line can be tracked, as the user progresses through the e-Book.

In this specific example embodiment, a server identifies the page or chapter in the book that Joe is reading. Karen and Jason are identified as being matched to Joe based on them having a digital copy of the e-Book, based on their progress coinciding with Joe's progress (i.e., all parties are at the same particular location in this e-Book), and based on their request to join an e-group for this particular topic.

Joe further indicates that he is interested in talking about the related topic for the next hour, next day, or for any other period of time. This information is stored in the server, where it can be systematically used to match users and to facilitate an information exchange amongst the end users. The collaborative protocols available for this particular example include chat rooms, a conference call, and a web sharing technology. The users are free to communicate using these possible collaborative platforms, or other communication modalities based on particular end-user preferences or capabilities.

Note that matching may take place based on a specific subject rather than based on a specific book. For example, two students one in the US and the other one in India can study arithmetic sequences. However, in this example, they are studying this same subject from two different e-books. In accordance with this embodiment, despite the fact that the two students use different e-books the system may still match them to form an e-group if it cannot find a match with people who use the identical e-book, or if the end user who requested the formation of the e-group asked that such a formation be done based on a topical area (and not necessarily an exact e-book). In another example, service provider element 14 may limit the service of matching people into e-groups only to those who purchased e-books from this specific outlet.

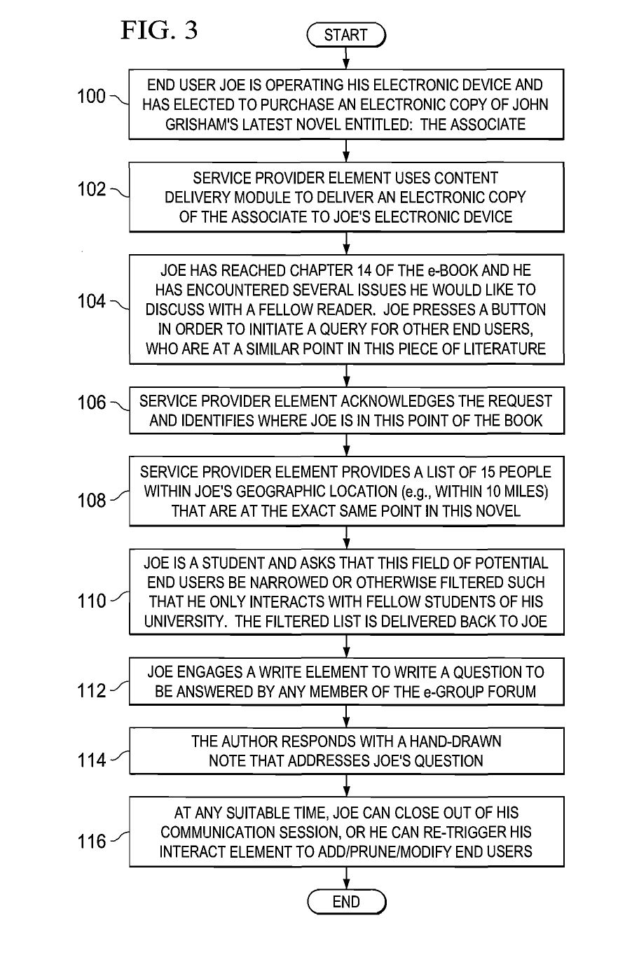

Turning to another example, FIG. 3 is a simplified flowchart illustrating an example operational flow involving system 10 in accordance with one embodiment that implicates an electronic copy of a book. The flow begins at step 100, where end user Joe is operating his electronic reading device 12a and has elected to purchase an electronic copy of John Grisham's latest novel entitled: The Associate. At step 102, service provider element 14 uses content delivery module 22 to deliver an electronic copy of The Associate to Joe's electronic reading device 12a.

At step 104, Joe has reached Chapter 14 of the e-Book and he has encountered several issues he would like to discuss with a fellow reader. In this example scenario, Joe's electronic reading device 12a includes a hard button interact element 18, and Joe presses this button in order to initiate a query for other end users, who are at a similar point in this piece of literature. At step 106, service provider element 14 acknowledges the request and identifies where Joe is in this point of the book (this could involve activities associated with user-tracking module 24). At step 108, service provider element 14 provides a list of 15 people within Joe's geographic location (e.g., within 10 miles) that are at the exact same point in this novel. Joe can access any commentary associated with these 15 end users (for example, by leveraging literary communications module 20, or through instant messaging, through accessing a certain website, etc.). In another example scenario, Joe may be reading The Dancing Girl of Izu by Yasunari Kawabata and would like to join an e-group with Japanese readers.

In this instance, Joe is a student and asks that this field of potential end users be narrowed or otherwise filtered such that he only interacts with fellow students of his university. Additionally, Joe asks that the author be included in these discussions. In this example, the author has made himself available for such discussions and is glad to participate in this reading group. The filtered list is delivered back to Joe, who now has a smaller group of four potential end users for discussing this portion of the book. This is illustrated by step 110. In yet another embodiment, Joe may join or create an ad-hoc e-group by a single button push on the interact button 18.

At step 112, Joe engages write element 28 (which in this instance is a hard button provided on electronic reading device 12a) to write a question to be answered by any member of the e-group forum. Such communications may be coordinated by literary communications module 20 residing in service provider element 14, or it may be facilitated in any other location such as through a service coupled to network 16. In this example, and at step 114, the author responds with a hand-drawn note that addresses Joe's question. In addition, the author has underlined various passages in Chapter 14 for Joe's consideration and to emphasize the author's points. In this example implementation, a WebEx protocol is used to facilitate these discussions such that all end users for this particular e-group can see the author's remarks and notations. Thus, the author has created an overlay of notations for Chapter 14, and the associated end users of this group can see this in real time, or have the option to upload this overlay onto their electronic copy of the book. In one sense, the author has dynamically created his own blog, in that he has elected to participate in communications involving his own work. At any suitable time, Joe can opt out of his communication session, or he can re-trigger his interact element 18 to add/prune/modify end users. This is depicted by step 116. In addition, Joe can continue to receive other notices for additional end user who may wish to join this session (or forum), or Joe may simply flush this set of end users and repopulate a group to discuss this particular piece of literature. In one example, an administrator within service provider element 14 (or an administrator responsible for a server coupled to network 16) may control how the groups are formed/dissolved/modified, but in alternative scenarios such control can reside with a single end user, or controlled in various other ways.

In one example implementation, a one-button push-to-join functionality is provided for e-group formations. For example, if Jason asked to be matched with someone who has a similar progress in an e-book (or a similar topical area), and if Joe issues a similar request with a single push button, the request is granted and Joe is connected with Jason. Such a connection could be done almost immediately such that the two end users involved in this scenario sense a seamless transition to a collaborative forum. This one button push feature can be used to find a peer, or to establish an e-team, and subsequently to connect to the peer or to the e-team. There could be some provisioning done in service provider element 14 and/or within electronic reading devices 12a-c to make such activities automatic. For example, users may establish a profile with their preferences in the service provider database. Service provider element 14 may utilize this profile to facilitate the one-button push-to-join functionality.

Software for triggering the initial reading-group request can be provided at various locations. In one example implementation, this software is provided in electronic reading devices 12a-c, as described herein. The ability to identify potential end users who are reading the same piece of literature can be provided within service provider element 14. In a similar vein, service provider element 14 can track an end user's progress through an e-book (e.g., through user-tracking module 24) and facilitate subsequent communications involving the grouped end users (e.g., through literary communications module 20). This could include various communication interfaces for the transmission/reception of group requests and of data related to progress through a piece of literature for anyone who holds an electronic copy of the piece of literature, etc., as identified herein. In one example, service provider element 14 is a server, but in other examples, service provider element 14 could be provided as a proprietary element, which could be provided in (or proximate to) electronic reading devices 12a-c, or be provisioned anywhere in the network. In another example, service provider element 14 is replaced by a server or a collection of servers attached to a network (e.g., a WAN) to perform the operations outlined herein.

As used herein in this Specification, the term ‘service provider element 14’ is meant to encompass software, hardware, servers, processors, network appliances, or any other suitable device, component, element, or object operable to exchange or to process the information outlined herein. Moreover, service provider element 14 may include any components, modules, interfaces, or objects that facilitate the operations thereof. This may be inclusive of appropriate algorithms and communication protocols that allow for the effective exchange of data or information.

In one example implementation, both service provider element 14 and electronic reading devices 12a-c include a processor, which executes code (e.g., software) for achieving some or all of the functionalities outlined herein (for example, transmitting a group request, tracking end-user progress, making determinations about which end users would be concurrently reading a given piece of literature, performing the filtering of end users, etc.). In other embodiments, this feature may be provided external to these elements or included in some other network device, or in a computer to achieve these intended functionalities. Alternatively, multiple elements (service provider element 14 and electronic reading devices 12a-c) can include this software (or reciprocating software) that can coordinate in order to achieve the processing or analyzing operations outlined herein. In still other embodiments, one, two, or all of these devices may include any suitable algorithms, hardware, software, components, modules, interfaces, or objects that facilitate the operations thereof.

Each of these elements (service provider element 14 and electronic reading devices 12a-c) can also include memory elements for storing information to be used in achieving the control and general processing mechanisms outlined herein. Additionally, each of these elements may include a processor that can execute software (e.g., logic) or an algorithm to perform the activities discussed in this Specification. These components may further keep information in any suitable memory element such as a random access memory (RAM), read only memory (ROM), erasable programmable ROM (EPROM), electronically erasable PROM (EEPROM), application specific integrated circuit (ASIC), software, hardware, or in any other suitable component, device, element, or object where appropriate and based on particular needs.

The functions outlined herein may be implemented by logic encoded in one or more tangible media (e.g., embedded logic provided in an application specific integrated circuit [ASIC], digital signal processor [DSP] instructions, software [potentially inclusive of object code and source code] to be executed by a processor, or other similar machine, etc.). In some of these instances, a memory element can store data used for the operations described herein, and/or the memory element can store software, logic, code, or processor instructions that are executed to carry out the activities described in this Specification. In one example, a processor could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Note that with the examples provided herein, interaction may be described in terms of two, three, four, or more elements. However, this has been done for purposes of clarity and example only. In certain cases, it may be easier to describe one or more of the functionalities of a given set of flows by only referencing a limited number of components or elements. It should be appreciated that system 10 of FIG. 1 (and its teachings) are readily scalable. System 10 can accommodate a large number of components, as well as more complicated or sophisticated arrangements and configurations. Accordingly, the examples provided should not limit the scope or inhibit the broad teachings of system 10 as potentially applied to a myriad of other architectures.

It is also important to note that the steps described with reference to the preceding FIGURES illustrate only some of the possible scenarios that may be executed by, or within, system 10. Some of these steps may be deleted or removed where appropriate, or these steps may be modified or changed considerably without departing from the scope of the discussed concepts. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 10 in that any suitable arrangements, chronologies, configurations, and timing mechanisms may be provided without departing from the teachings of the discussed concepts.

Numerous other changes, substitutions, variations, alterations, and modifications may be ascertained to one skilled in the art and it can be intended that the discussed concept encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. An apparatus, comprising:
a service provider element that includes:
a user-tracking module configured to receive progress data associated with an end user reading an electronic piece of literature using an electronic reading device, wherein the service provider element is configured to:
receive a request from the end user to interact with an additional end user about the electronic piece of literature, and
identify the additional end user who is also reading the electronic piece of literature in order to form a reading group associated with the electronic piece of literature.

2. The apparatus of claim 1, wherein the progress data associated with the end user includes a subject associated with the electronic piece of literature and attributes that identify an academic level for the electronic piece of literature.

3. The apparatus of claim 1, wherein the user-tracking module is further configured to identify progress data for the additional end user such that the reading group is formed of end users who are at a similar location in the electronic piece of literature.

4. The apparatus of claim 1, further comprising:
a literary communications module configured to provide a communications platform for the end users to interact based on the electronic piece of literature, wherein the communications platform provides a forum in which the end users can write text to each other about the piece of electronic literature.

5. The apparatus of claim 4, wherein the communications platform is associated with a protocol, the protocol being selected from a group of protocols consisting of:
a) instant messaging;
b) e-mail;
c) video conferencing;
d) texting;
e) short message service;
f) Wi-Fi;
g) wireless communications;
h) Internet; and
i) audio communication.

6. The apparatus of claim 1, wherein the service provider element is further configured to employ a filtering operation based on input from the end user such that the reading group is narrowed through the filtering operation.

7. The apparatus of claim 1, wherein the request is generated by a single trigger from the end user, and wherein the request initiates formation of the reading group associated with the electronic piece of literature and the request is used to subsequently connect end users who are part of the reading group.

8. The apparatus of claim 1, wherein the piece of electronic literature is selected from a group of pieces of literature consisting of:
a) books;
b) magazines;
c) articles;
d) journals; and
e) newspapers.

9. A method, comprising:
receiving progress data associated with an end user reading an electronic piece of literature using an electronic reading device;
receiving a request from the end user to interact with an additional end user about the electronic piece of literature; and
identifying the additional end user who is also reading the electronic piece of literature in order to form a reading group associated with the electronic piece of literature.

10. The method of claim 9, wherein the identifying further includes identifying progress data for the additional end user such that the reading group is formed of end users who are at a similar location in the electronic piece of literature.

11. The method of claim 9, wherein the progress data associated with the end user includes a subject associated with the electronic piece of literature and attributes that identify an academic level for the electronic piece of literature.

12. The method of claim 9, further comprising:
providing a communications platform for the end users to interact based on the electronic piece of literature, wherein the communications platform provides a forum in which the end users can write text to each other based on the piece of electronic literature.

13. The method of claim 9, wherein the identifying further includes employing a filtering operation based on input from the end user such that the reading group is narrowed through the filtering operation.

14. The method of claim 9, further comprising:
directing the reading group to converse with each other via an Instant messaging application, an e-mail application, a video conference application, a web-sharing application, or an audio application involving the electronic reading device capable of being used to read the electronic piece of literature.

15. A system, comprising:
means for receiving progress data associated with an end user reading an electronic piece of literature using an electronic reading device;
means for receiving a request from the end user to interact with an additional end user about the electronic piece of literature; and
means for identifying the additional end user who is also reading the electronic piece of literature in order to form a reading group associated with the electronic piece of literature.

16. The system of claim 15, wherein the means for identifying further includes identifying progress data for the additional end user such that the reading group is formed of the end users who are at a similar location in the electronic piece of literature.

17. Logic encoded in one or more tangible media for execution and when executed by a processor is operable to:
receive progress data associated with an end user reading an electronic piece of literature using an electronic reading device;
receive a request from the end user to interact with an additional end user about the electronic piece of literature; and
identify the additional end user who is also reading the electronic piece of literature in order to form a reading group associated with the electronic piece of literature.

18. The logic of claim 17, wherein the identify logic further includes logic to identify progress data for the additional end user such that the reading group is formed of the end users who are at a similar location in the electronic piece of literature.

19. The logic of claim 17, wherein the progress data associated with the end user includes a chapter and a page identification associated with the electronic piece of literature.

20. The logic of claim 17, wherein the logic is further operable to:
provide a communications platform for the end users to interact based on the electronic piece of literature, wherein the communications platform provides a forum in which the end users can write text to each other about the piece of electronic literature.
